(19) United States
(12) Patent Application Publication
(10) Pub. No.: US 2020/0244536 A1
(43) Pub. Date: Jul. 30, 2020

(54) CLUSTER FORMATION

(71) Applicant: Hewlett Packard Enterprise Development LP, Houston, TX (US)

(72) Inventor: Ajaya Kumar Panda, Bangalore Karnataka (IN)

(21) Appl. No.: 16/256,782

(22) Filed: Jan. 24, 2019

(51) Int. Cl. H04L 12/24; G06F 8/61; G06F 9/50; G06F 9/455

(52) U.S. Cl. CPC H04L 41/0893; H04L 41/0806; G06F 8/63; G06F 9/451; G06F 9/45558; G06F 2009/45562; G06F 9/5077

(57) ABSTRACT

Some examples described herein relate to cluster formation. In an example, on a cluster management system, a cluster formation image may be provided for forming a cluster of nodes. The cluster formation image may comprise a compressed version of an operating system, and a plan script comprising custom attributes for customizing the operating system and instructions for forming the cluster. In response to a selection of the cluster formation image, the cluster formation image may be provided from the cluster management system to each of the nodes. The operating system may be installed on each of the nodes, and the operating system on each of the nodes may be customized based on the custom attributes in the plan script. The nodes may be formed into a cluster based on the instructions in the plan script.

### BACKGROUND

Cluster computing evolved as a means of doing parallel computing work in the 1960s. Arguably, one of the primary motivations that led to cluster computing was the desire to link multiple computing resources, which were underutilized, for parallel processing. Computer clusters may be configured for different purposes, for example, high-availability and load balancing.

### BRIEF DESCRIPTION OF THE DRAWINGS

For a better understanding of the solution, examples will now be described, with reference to the accompanying drawings, in which:

FIG. 1 illustrates an example cluster computer system;

FIG. 2 illustrates another example cluster computer system;

FIG. 3 illustrates an example cluster management system;

FIG. 4 illustrates an example method of forming a cluster; and

FIG. 5 is a block diagram of an example system including instructions in a machine-readable storage medium for forming a cluster.

### DETAILED DESCRIPTION OF THE INVENTION

A “cluster computer system” (also “computer cluster” or “cluster”) may be defined as a group of computing systems (for example, servers) and other resources (for example, storage, network, etc.) that act like a single system. A computer cluster may be considered as a type of parallel or distributed processing system, which may consist of a collection of interconnected computer systems cooperatively working together as a single integrated resource. In other words, a cluster is a single logical unit consisting of multiple computers that may be linked through a high speed network. A “sub-cluster” may refer to a subset of a cluster. A cluster may be divided into zero or more sub-clusters (or partitions) of live nodes. Each live node has a view of sub-cluster membership. A computing system in a cluster may be referred to as a “node”. In an example, each node in a cluster may run its own instance of an operating system.

Clusters may be deployed to improve performance and availability since they basically act as a single, powerful machine. They may provide faster processing, increased storage capacity, and better reliability.

In order to create a cluster (e.g., in a traditional datacenter), a customer may perform a number of steps. First, the customer may install an operating system (OS) on various individual nodes (e.g., servers). Once the OS installation is complete, various parameters (e.g., IP address) may be personalized for each of the nodes, and then a cluster may be created. This is a time consuming process that may include manual intervention from various users such as an OS administrator (e.g., for OS installation and personalization), a network administrator (e.g., for enabling communication between various nodes), and a storage administrator (e.g., for providing a common storage).

To address these technical challenges, the present disclosure describes various examples for cluster formation. In an example, on a cluster management system, a cluster formation image may be provided for forming a cluster of nodes. The cluster formation image may comprise a compressed version of an operating system, and a plan script comprising custom attributes for customizing the operating system and instructions for forming the cluster. In an example, in response to a selection of the cluster formation image, the cluster formation image may be provided from the cluster management system to each of the nodes. Thereupon, the operating system may first be installed on each of the nodes, and the OS on each of the nodes may be customized based on the custom attributes in the plan script. The nodes may then be formed into a cluster based on the instructions in the plan script.

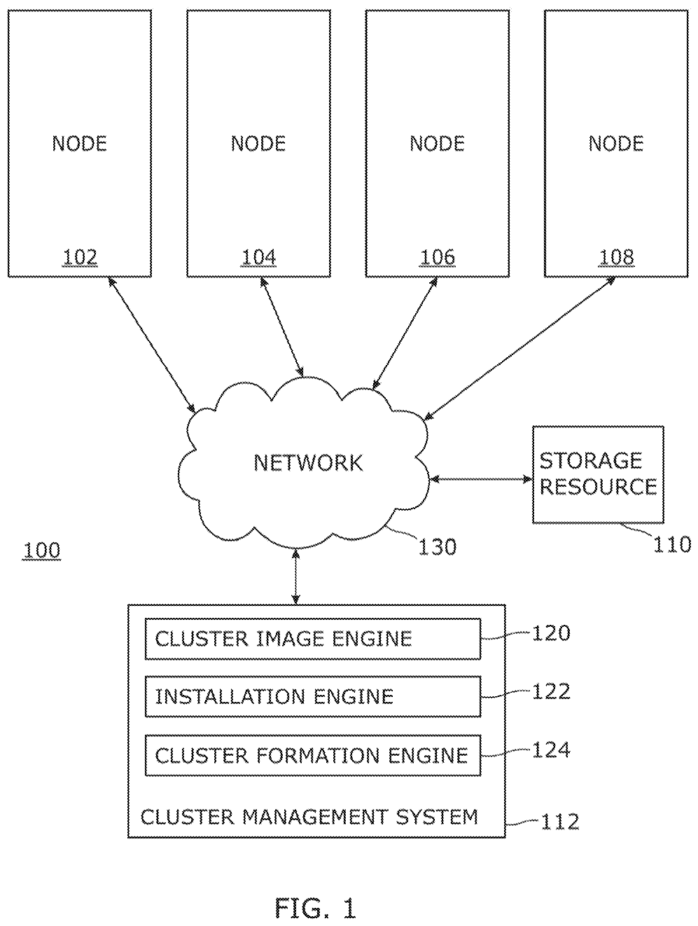

FIG. 1 illustrates an example cluster computer system 100. Cluster computer system 100 may include nodes 102, 104, 106, and 108, a storage resource 110, and a cluster management system 112. Although four nodes and one storage resource are shown in FIG. 1, other examples of this disclosure may include less or more than four nodes, and less or more than one storage resource.

As used herein, the term “node” may refer to any type of computing device capable of reading machine-executable instructions. Examples of the computing device may include, without limitation, a server, a desktop computer, a notebook computer, a tablet computer, and the like. Thus, in an example, each of the nodes 102, 104, 106, and 108 may be a compute node comprising a processor. In an example, each of the nodes 102, 104, 106, and 108 may act as a failover node. In the event of a failure or unavailability of a node, any of the remaining nodes may take over the functions of the failed node. In an example, nodes 102, 104, 106, and 108 may be part of a datacenter.

Storage resource 110 may be a storage device. The storage device may be an internal storage device, an external storage device, or a network attached storage device. Some non-limiting examples of the storage device may include a hard disk drive, a storage disc (for example, a CD-ROM, a DVD, etc.), a storage tape, a solid state drive (SSD), a USB drive, a Serial Advanced Technology Attachment (SATA) disk drive, a Fibre Channel (FC) disk drive, a Small Computer System Interface (SCSI) disk drive, a Serial Attached SCSI (SAS) disk drive, a magnetic tape drive, an optical jukebox, and the like. In an example, storage node 110 may be a Direct Attached Storage (DAS) device, a Network Attached Storage (NAS) device, a Redundant Array of Inexpensive Disks (RAID), a data archival storage system, or a block-based device over a storage area network (SAN). In another example, storage resource 110 may be a storage array, which may include a storage drive or plurality of storage drives (for example, hard disk drives, solid state drives, etc.). In an example, storage resource 110 may be a distributed storage node, which may be part of a distributed storage system that may include a plurality of storage nodes. In another example, storage resource 110 may be a disk array or a small to medium sized server re-purposed as a storage system with similar functionality to a disk array having additional processing capacity.

Cluster management system 112 may be any type of computing device capable of reading machine-executable instructions. Examples of the computing device may include, without limitation, a server, a desktop computer, a notebook computer, a tablet computer, and the like

In an example, nodes 102, 104, 106, and 108, storage resource 110, and cluster management system 112 may be communicatively coupled via a computer network 130. Computer network 130 may be a wireless or wired network. Computer network 130 may include, for example, a Local Area Network (LAN), a Wireless Local Area Network (WAN), a Metropolitan Area Network (MAN), a Storage Area Network (SAN), a Campus Area Network (CAN), or the like. Further, computer network 130 may be a public network (for example, the Internet) or a private network (for example, an intranet).

Storage resource 110 may communicate with nodes 102, 104, 106, 108 via a suitable interface or protocol such as, but not limited to, Fibre Channel, Fibre Connection (FICON), Internet Small Computer System Interface (iSCSI), HyperSCSI, and ATA over Ethernet.

In the example of FIG. 1, cluster management system 112 may include a cluster image engine 120, an installation engine 122, and a cluster formation engine 124.

Engines 120, 122, and 124 may each include any combination of hardware and programming to implement the functionalities of the engines described herein. In examples described herein, such combinations of hardware and software may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of cluster management system 112. In some examples, the at least one machine-readable storage medium may store instructions that, when executed by the at least one processing resource, at least partially implement some or all engines of cluster management system 112. In such examples, cluster management system 112 may include the at least one machine-readable storage medium storing the instructions and the at least one processing resource to execute the instructions.

In an example, cluster image engine 120 on cluster management system 112 may provide a cluster formation image for forming a cluster of nodes (for example, nodes 102, 104, 106, and 108). The cluster formation image may comprise a compressed version of an operating system. Some non-limiting examples of the operating system may include Microsoft Windows®, VMware ESX®, Red Hat Enterprise Linux®, and SUSE Linux Enterprise Server (SLES).® In an example, the compressed version of the operating system may include a bootable operating system image. In another example, the compressed version of the operating system may include an application. The compressed version of the operating system may include an input/output (VO) driver.

The cluster formation image may also comprise a plan script(s) comprising custom attributes for customizing the operating system. Some non-limiting examples of the custom attributes may include a host name, a domain name, a cluster name, an IP address, a subnet mask, a gateway, name of a physical volume, name of a logical volume, name of a volume group, name of a quorum device, and a password. A custom attribute may be, for example, of a type string, an integer or a password. The cluster formation image may also comprise machine-readable instructions for forming a cluster of nodes (for example, nodes 102, 104, 106, and 108).

In an example, cluster management system 112 may include a user interface (for example, a Graphical User Interface (GUI) or a Command Line Interface (CLI)). The user interface may allow a user to select a cluster formation image for forming a cluster of nodes, for example, from nodes 102, 104, 106, and 108.

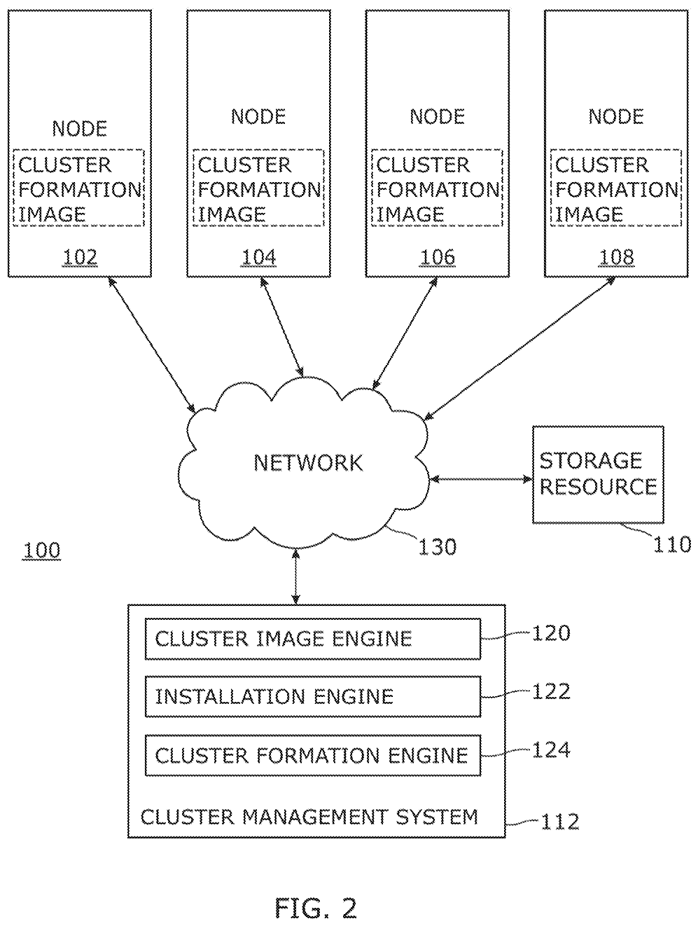

In an example, in response to a selection of a cluster formation image, installation engine 122 may provide the cluster formation image from the cluster management system 112 to each of the nodes (for example, nodes 102, 104, 106, and 108). This is illustrated in FIG. 2. In response, each of the nodes that receives the cluster formation image may uncompress the compressed version of the operating system from the cluster formation image, and install the uncompressed operating system. Once the operating system is installed, the operating system on each of the nodes may be customized based on the custom attributes present in the plan script.

Once the operating system on each of the nodes is customized based on the custom attributes, cluster formation engine 124 may form the nodes into a cluster based on the instructions in the plan script.

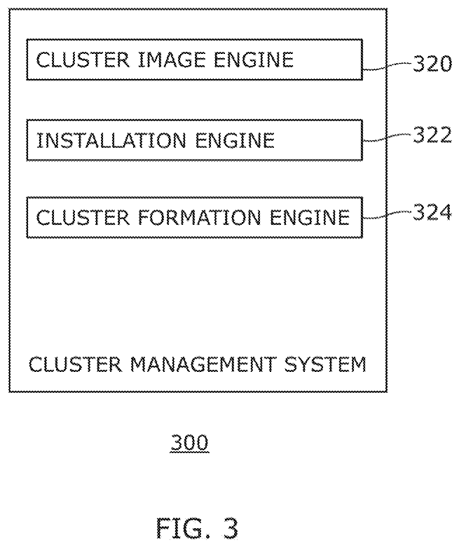

FIG. 3 illustrates a cluster management system 300 in a cluster computer system (e.g., 100). In an example, cluster management system 300 may be similar to cluster management system 112 of FIG. 1, in which like reference numerals correspond to the same or similar, though perhaps not identical, components. For the sake of brevity, components or reference numerals of FIG. 3 having a same or similarly described function in FIG. 1 are not being described in connection with FIG. 3. Accordingly, components of cluster management system 300 that are similarly named and illustrated in reference to FIG. 1 may be considered similar.

In an example, cluster management system 300 may include any type of computing device capable of reading machine-executable instructions. Examples of the computing device may include, without limitation, a server, a desktop computer, a notebook computer, a tablet computer, and the like.

In an example, cluster management system 300 may include a cluster image engine 320, an installation engine 322, and a cluster formation engine 324 that may perform functionalities similar to those described earlier in reference to cluster image engine 120, installation engine 122, and cluster formation engine 124.

In an example, cluster image engine 320 may provide a cluster formation image for forming a cluster of nodes. The cluster formation image may comprise a compressed version of an operating system, and a plan script comprising custom attributes for customizing the operating system and instructions for forming the cluster. In response to a selection of the cluster formation image, installation engine 322 may provide the cluster formation image from the cluster management system 300 to each of the nodes. In response, the operating system may be installed on each of the nodes. Once installed, the operating system on each of the nodes may be customized based on the custom attributes in the plan script. Cluster formation engine 324 may form the nodes into a cluster based on the instructions in the plan script.

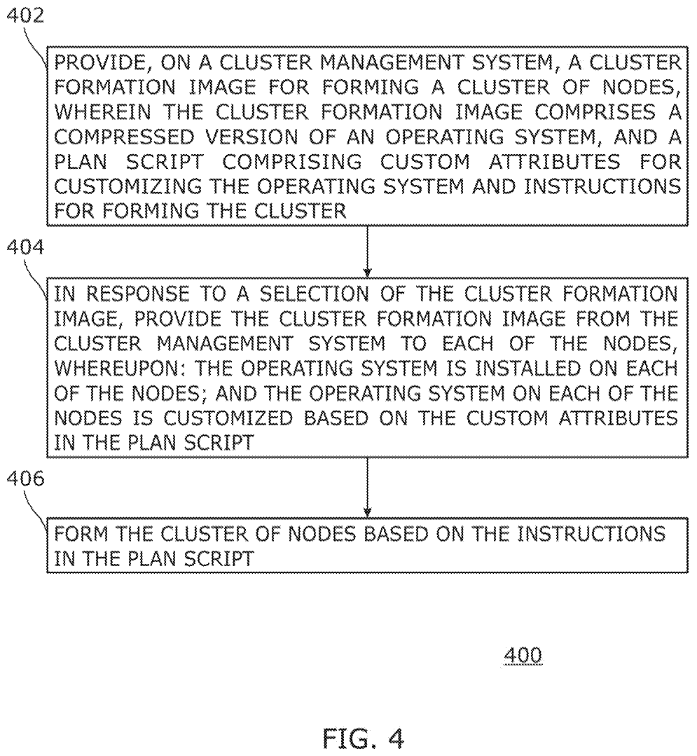

FIG. 4 illustrates a method 400 of forming a cluster, according to an example. The method 400, which is described below, may be executed on a cluster management system such 112 of FIG. 1 or 300 of FIG. 3. However, other computing platforms may be used as well.

At block 402, on a cluster management system, a cluster formation image may be provided for forming a cluster of nodes. The cluster formation image may comprise a compressed version of an operating system, and a plan script comprising custom attributes for customizing the operating system and instructions for forming the cluster. At block 404, in response to a selection of the cluster formation image, the cluster formation image may be provided from the cluster management system to each of the nodes. Thereupon, the operating system may first be installed on each of the nodes, and the OS on each of the nodes may be customized based on the custom attributes in the plan script. At block 406, the nodes may be formed into a cluster based on the instructions in the plan script.

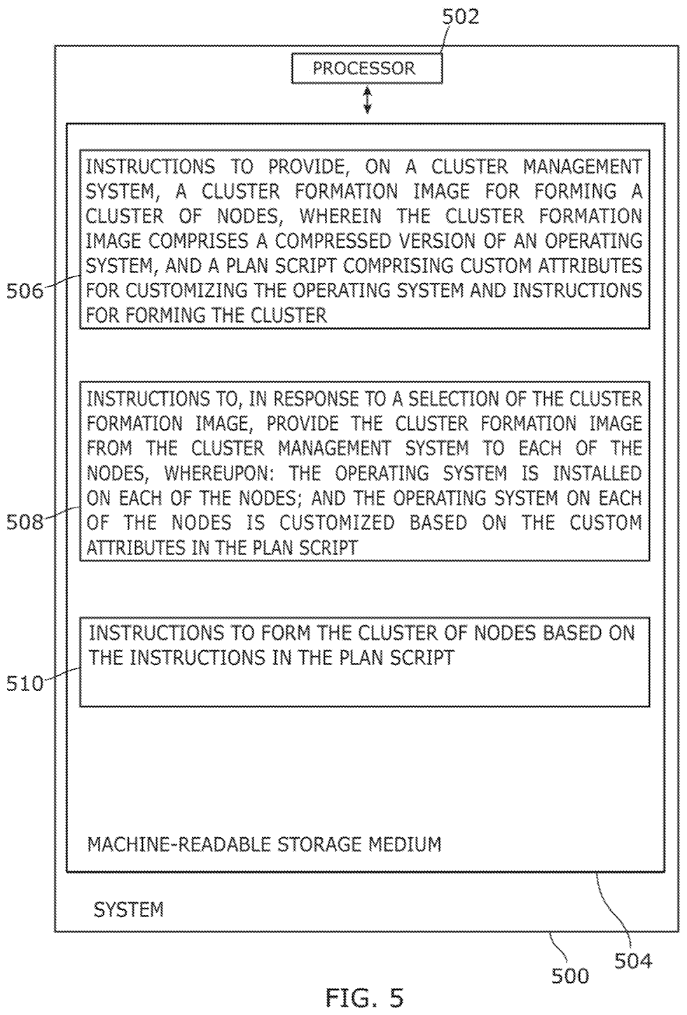

FIG. 5 is a block diagram of an example system 500 including instructions in a machine-readable storage medium for forming a cluster. System 500 includes a processor 502 and a machine-readable storage medium 504 communicatively coupled through a system bus. In an example, system 500 may be analogous to cluster management system such 112 of FIG. 1 or 300 of FIG. 3. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like.

In an example, machine-readable storage medium 504 may be a non-transitory machine-readable medium. Machine-readable storage medium 504 may store monitoring instructions 506, 508, and 510. In an example, instructions 506 may be executed by processor 502 to provide, on a cluster management system, a cluster formation image for forming a cluster of nodes (e.g., 102, 104, 106, and 108). The cluster formation image may comprise a compressed version of an operating system, and a plan script comprising custom attributes for customizing the operating system and instructions for forming the cluster. In response to a selection of the cluster formation image, instructions 508 may be executed by processor 502 to provide the cluster formation image from the cluster management system to each of the nodes, whereupon: the operating system may be installed on each of the nodes; and the operating system on each of the nodes may be customized based on the custom attributes in the plan script. Instructions 510 may then be executed by processor 502 to form a cluster of the nodes, based on the instructions in the plan script. In an example, machine-readable storage medium 504 may further include instructions to create the cluster formation image. In an example, machine-readable storage medium 504 may further include instructions to create the plan script.

For the purpose of simplicity of explanation, the example method of FIG. 4 is shown as executing serially, however it is to be understood and appreciated that the present and other examples are not limited by the illustrated order. The example systems of FIGS. 1, 2, 3 and 5, and method of FIG. 4 may be implemented in the form of a computer program product including computer-executable instructions, such as program code, which may be run on any suitable computing device in conjunction with a suitable operating system (for example, Microsoft Windows®, Linux®, UNIX®, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It may be noted that the above-described examples of the present solution is for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution.

1. A method of cluster formation, comprising:
providing, on a cluster management system, a cluster formation image for forming a cluster of nodes, wherein the cluster formation image comprises a compressed version of an operating system, and a plan script comprising custom attributes for customizing the operating system and instructions for forming the cluster;
in response to a selection of the cluster formation image, providing the cluster formation image from the cluster management system to each of the nodes, whereupon:
the operating system is installed on each of the nodes; and
the operating system on each of the nodes is customized based on the custom attributes in the plan script; and
forming the cluster of nodes based on the instructions in the plan script.

2. The method of claim 1, wherein the compressed version of the operating system includes a bootable operating system image.

3. The method of claim 1, wherein the compressed version of the operating system includes an application.

4. The method of claim 1, further comprising creating the cluster formation image.

5. The method of claim 1, further comprising creating the plan script.

6. The method of claim 1, further comprising providing a user interface for the selection of the cluster formation image.

7. A cluster management system, comprising:
a cluster image engine to provide a cluster formation image for forming a cluster of nodes, wherein the cluster formation image comprises a compressed version of an operating system, and a plan script comprising custom attributes for customizing the operating system and instructions for forming the cluster;
an installation engine to, in response to a selection of the cluster formation image, provide the cluster formation image from the cluster management system to each of the nodes, whereupon:
the operating system is installed on each of the nodes; and
the operating system on each of the nodes is customized based on the custom attributes in the plan script; and
a cluster formation engine to form the cluster of nodes based on the instructions in the plan script.

8. The system of claim 7, wherein the custom attributes include one of a host name, a domain name, a cluster name, an IP address, a subnet mask, a gateway, name of a physical volume, name of a logical volume, name of a volume group, name of a quorum device, and a password.

9. The system of claim 7, wherein the compressed version of the operating system includes an I/O driver.

10. The system of claim 7, wherein the node includes a compute node.

11. The system of claim 7, wherein each of the nodes act as a failover node.

12. The system of claim 7, wherein the operating system includes one of Microsoft Windows®, VMware ESX®, Red Hat Enterprise Linux®, and SUSE Linux Enterprise Server (SLES)®.

13. The system of claim 7, wherein the nodes are part of a datacenter.

14. The system of claim 7, further comprising a user interface for the selection of the cluster formation image.

15. A non-transitory machine-readable storage medium comprising instructions, the instructions executable by a processor to:
provide, on a cluster management system, a cluster formation image for forming a cluster of nodes, wherein the cluster formation image comprises a compressed version of an operating system, and a plan script comprising custom attributes for customizing the operating system and instructions for forming the cluster;
in response to a selection of the cluster formation image, provide the cluster formation image from the cluster management system to each of the nodes, whereupon:
the operating system is installed on each of the nodes; and
the operating system on each of the nodes is customized based on the custom attributes in the plan script; and
form the cluster of nodes based on the instructions in the plan script.

16. The machine-readable storage medium of claim 15, further comprising instructions to create the cluster formation image.

17. The machine-readable storage medium of claim 15, further comprising instructions to create the plan script.

18. The machine-readable storage medium of claim 15, wherein the compressed version of the operating system includes an application.

19. The machine-readable storage medium of claim 15, wherein the compressed version of the operating system includes a bootable operating system image.

20. The machine-readable storage medium of claim 15, wherein the nodes are part of a datacenter.
